(19) United States
(12) Patent Application Publication
(10) Pub. No.: US 2020/0005383 A1
(43) Pub. Date: Jan. 2, 2020

(54) DATA VALIDATION AND PRESENTATION

(71) Applicant: Microsoft Technology Licensing, LLC, Redmond, WA (US)

(72) Inventors: ASAD A. SIDDIQUI, Mountain House, CA (US); ABHISHEK JOSHI, Newark, CA (US); MICHELLE M. LAFFEN, Los Gatos, CA (US); ANTHONY P. DAY, San Jose, CA (US)

(21) Appl. No.: 16/022,640

(22) Filed: Jun. 28, 2018

(51) Int. Cl. G06Q 30/06; G06Q 30/04

(52) U.S. Cl. CPC G06Q 30/0635; G06Q 30/04

(57) ABSTRACT

A server computer and related methods for presenting and validating accrual data are disclosed. In some embodiments, the server computer is programmed to cause presentation of one or more graphical user interfaces by different computers in the computing environment for accrual processing during an accrual period.

### TECHNICAL FIELD

The present disclosure relates to data validation and presentation, and more specifically to automatically improving data validity and auditability through a graphical user interface.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

With present-day enterprises, a financial transaction can involve many stages, such as from requesting a purchase requisition to closing a purchase order, and many systems for transaction and data management. Accrual-based accounting, which adjusts for revenue earned and expenses incurred but not yet recorded into accounts from time to time, is generally an integral part of enterprise-level financial analysis and planning according to the generally accepted accounting principles. In a financial transaction, purchase orders indicating the goods or services ordered and invoices indicating the costs of those goods or services may not match up or otherwise not indicate expected amounts at the end of an accrual period for a variety of reasons. For example, there might be an agreement to invoice some of the ordered goods or services later. It would be useful to streamline accrual processing through the many systems while helping ensure data validity and auditability through at least one specifically-designed graphical user interface (“GUI”) governed by specific rules.

### BRIEF DESCRIPTION OF THE DRAWINGS

In the drawings:

FIG. 1 illustrates an example networked computer system in which various embodiments may be practiced.

FIG. 2 illustrates example computer components of an accrual server computer.

FIG. 3 illustrates an example GUI presented by requester computers having a screen for entering, reviewing, and updating accrual data associated with a purchase order.

FIG. 4A illustrates an example GUI having a screen for handling a zero accrual amount for a line of the purchase order.

FIG. 4B illustrates an example GUI having a screen for handling an accrual amount that is larger than the remaining amount for a line of the purchase order.

FIG. 4C illustrates an example GUI having a screen for handling an accrual amount that is larger than a specific threshold for a line of the purchase order.

FIG. 5A illustrates an example GUI presented by a planning and analysis computers having a screen for reviewing accrual data and associated invoice data and updating the accrual data associated with one or more purchase orders.

FIG. 5B illustrates an example GUI having a screen for issuing an instruction on managing data related to a line of the purchase order.

FIG. 6 illustrates an example GUI presented by a planning and analysis computer having a screen for certifying one or more accruals associated with certain purchase orders.

FIG. 7 illustrates an example GUI presented by a requester computer or a planning and analysis computer having a screen for reviewing accrual data and associated invoice data for a project and updating the accrual data associated with one or more categories.

FIG. 8 illustrates an example process performed by the accrual server computer.

FIG. 9 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An accrual server computer (server) and related methods for presenting and validating accrual data are disclosed. In some embodiments, the server is programmed to cause presentation of one or more graphical user interfaces by different computers in the computing environment for accrual processing during an accrual period.

In some embodiments, a first GUI presented by a requester computer shows relevant data for specific lines of a purchase order, such as the order price or the amounts invoiced so far, and also allows initial updates of an accrual amount to an amount different from the expected accrual amount, namely the difference between the order price and the amounts invoiced so far. The first GUI also manages multiple screens to ensure that valid values are inputted and proper justifications are provided for inputting various accrual amounts different from the expected amounts. The accrual data submitted by the requester computer, including the initial updates of the accrual amounts, are to be reviewed and certified by a planning and analysis computer.

In some embodiments, a second GUI presented by a planning and analysis computer shows relevant data for all lines of multiple purchase orders that might have been assigned to the planning and analysis computer for certification and allows subsequent updates of an accrual amount to an amount different from the amount initially submitted by a requester computer. The relevant data include corresponding invoices and log entries related to the accrual data. The entries can document the initial updates of the accrual data, previous certification of the accrual data, or previous de-certification of the accrual data. The second GUI maintains synchronization between the display of the accrual data for individual lines of the purchase orders and the display of corresponding log entries related to those individual lines. The data submitted by the planning and analysis computer, including the subsequent updates of the accrual amounts by the planning and analysis computer, are to be reviewed and finally approved by an accounting computer.

The server offers several technical benefits. The server avoids many network trips required in previous approaches. Traditionally, a planning and analysis computer often needs to repeatedly retrieve almost arbitrary pieces of accrual-related data from the general ledger system and communicate the data to multiple accounting computers or requester computers due to uncertainty of the accrual status, among other things. The server enables streamlining of the accrual process and controlled presentation of customized views of the data to relevant parties, eliminating much of the redundancy in requesting and servicing accrual-related data. Furthermore, the server supports sophisticated GUIs that enforces specific data validation and analysis rules. These GUIs enable easy access and ready analysis of relevant data. These GUIs also ensure availability of valid data and supporting evidence. Through these GUIs, complex yet efficient accrual data management become possible.

### Example Computing Environments

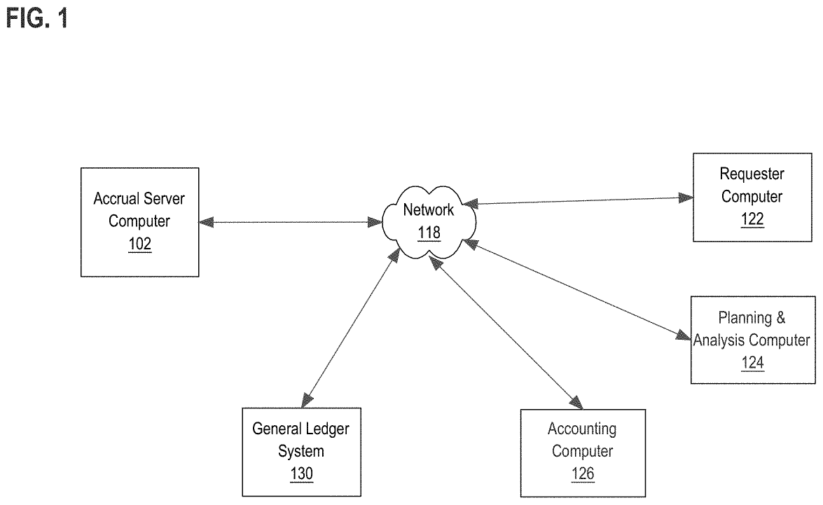

FIG. 1 illustrates an example networked computer system in which various embodiments may be practiced. FIG. 1 is shown in simplified, schematic format for purposes of illustrating a clear example and other embodiments may include more, fewer, or different elements connected in various manners.

In some embodiments, the networked computer system comprises an accrual server computer (server) 102, a requester computer 122, a planning and analysis computer 124, an accounting computer 126, and a general ledger system 130, which are communicatively coupled directly or indirectly via one or more networks 118. The different components of the networked computer system can reside in the same or different computer network domains.

In some embodiments, the server 102 broadly represents one or more computers, virtual computing instances, and/or instances of a server-based application that is programmed or configured to host or execute functions including but not limited to communicating with other systems involved in accrual processing and managing accrual-related data and associated graphical user interfaces (GUIs). The accrual-related data may include accrual data as well as purchase requisitions, purchase orders, invoices, receipts, or related agreements. The server 102 can comprise a server farm, a cloud computing platform, a parallel computer, special-purpose hardware, or any other computing facility with sufficient computing power in data processing, data storage, and network communication for the above-described functions.

The requester computer 122 is programmed to generally communicate with the general ledger system 130 to submit original data leading to accrual computation, such as purchase orders and invoices, and with the server 102 to submit accrual data, such as accrual amounts. The planning and analysis computer 124 is programmed to generally communicate with the server 102 to review, update, or certify accrual data. The accounting computer 126 is programmed to generally communicate with the server 102 to further review, update, or approve the accrual data.

Each of the requester computer 122, planning and analysis computer 124, and accounting computer 126 may comprise computing facility with sufficient computing power in data processing, data storage, and network communication for the above-described functions. In some embodiments, each of the requester computer 122, planning and analysis computer 124, and accounting computer 126 can comprise a desktop computer, laptop computer, tablet computer, smartphone, wearable device, etc.

The general ledger system 130 is programmed to generally communicate with the requester computer 122 and the server 102 to host, manage, and provide accrual-related data. The general ledger system 130 may similarly comprise computing facility with sufficient computing power in data processing, data storage, and network communication for the above-described functions. In certain embodiments, the general ledger system can be incorporated into the server 102.

The networks 118 may be implemented by any medium or mechanism that provides for the exchange of data between the various elements of FIG. 1. Examples of network 118 include, without limitation, one or more of a cellular network, communicatively coupled with a data connection to the computing devices over a cellular antenna, a near-field communication (NFC) network, a Local Area Network (LAN), a Wide Area Network (WAN), the Internet, a terrestrial or satellite link, etc.

In some embodiments, each requester computer 122 is programmed to submit purchase orders, invoices, or related data to the general ledger system 130. For each accrual period, the server 102 is programmed or configured with data structures and/or database records that are arranged to initiate and complete accrual processing through one or more rule-based GUIs as follows. Initially, the server 102 is programmed to reconcile the purchase orders and invoices and identify potential accruals for further processing. The requester computer 122 is programmed to then submit requests to the server 102 to update potential accruals or submit actual accruals. The server 102 is programmed to evaluate the accrual data or collect additional data from the requester computer 122 for validation or auditing purposes. Next, the planning and analysis computer 124 is programmed to submit requests to the server 102 to further review and analyze and ultimately certify the accrual data. The server 102 is programmed to update the status of the accrual data or collect some more data from the planning and analysis computer 124 for validation or auditing purposes. Next the accounting computer 126 is programmed to submit requests to the server 102 to finally approve the accrual data or instead decertify the accrual data upon identification of potential issues. The server 102 is programmed to also update the status of the accrual data and, as necessary, communicate with the requester computer 122 or the planning analysis computer 124 to repeat the review or analysis process until final approval is obtained from the accounting computer 126.

### Example Computer Components

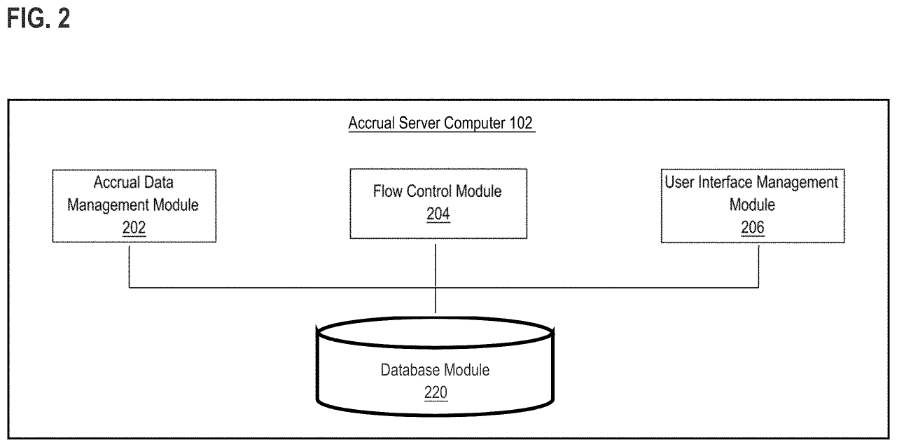

FIG. 2 illustrates example computer components of an accrual server computer. FIG. 2 is shown in simplified, schematic format for purposes of illustrating a clear example and other embodiments may include more, fewer, or different elements connected in various manners. Each of the functional components can be implemented as software components, general or specific-purpose hardware components, firmware components, or any combination thereof. A storage component can be implemented using any of relational databases, object databases, flat file systems, or JSON stores. A storage component can be connected to the functional components locally or through the networks using programmatic calls, remote procedure call (RPC) facilities or a messaging bus. A component may or may not be self-contained. Depending upon implementation-specific or other considerations, the components may be centralized or distributed functionally or physically.

In some embodiments, the server 102 comprises an accrual data management module 202, a flow control module 204, and a user interface management module 206. In addition, the server 102 comprises a database module 220.

In some embodiments, the flow control module 204 is programmed to direct the flow of accrual data through various systems for update, review, certification, and so on. In directing the flow, the flow control module 204 can be programmed to send notifications of data availability to specific systems and receive confirmation of respective processing of the accrual data. The direction may include determining whether the conditions of certain triggers are satisfied and thus the actions of those triggers need to be performed. Depending on the results of the analysis performed by the accrual data management module 202, the flow control module 204 is programmed to further coordinate with various systems to enhance, correct or validate existing accrual data.

In some embodiments, the accrual data management module 202 is programmed to process and analyze accrual-related data. Such processing may include identifying potential accruals, associating accrual updates with underlying financial documents, comparing suggested accrual amounts with internal thresholds or expected ranges, determining missing or incorrect accruals, correlating accrual updates with accrual audit data, managing support data for accrual updates, and so on.

In some embodiments, the user interface management module 206 is programmed to manage GUIs associated with accrual processing. The user interface management module 206 is programmed to cooperate with the accrual data management module 202 to enforce specific data validation and auditing rules. The user interface management module 206 is programmed to also arrange various graphical elements in specific ways to expedite provision, review, and analysis of accrual-related data.

In some embodiments, the database 220 is programmed or configured to manage relevant data structures and store relevant data for functions performed by the server 102. The data may be related to updates of accrual amounts, triggers associated with such updates, logs of such updates or related audit trails, comments for updating accrual amounts, associations with supporting documents, certifications or de-certifications of accrual data, or statistics or metrics associated with accrual data.

### Example Processes

In some embodiments, the server 102 is programmed to retrieve relevant data from the general ledger system 130 for accrual processing during each accrual period. The relevant data generally includes purchase orders indicating an order of goods or services placed before or during the accrual period and corresponding invoices each indicating a billed amount for certain purchased or sold goods services issued during the accrual period. For example, a purchase order may include multiple lines for multiple items to be purchased or sold, and a separate invoice might correspond to each of the multiple lines. The server 102 is programmed to further compute expected accruals for the accrual period generally as the difference between the amount indicated in a purchase order and the amount indicated in each of the corresponding invoices. In other embodiments, the server 102 is programmed to considered receipts or a combination of invoices and receipts instead of invoices alone. With the potential or expected accruals available, the server 102 can be programmed to make a general announcement that accrual data is ready for review.

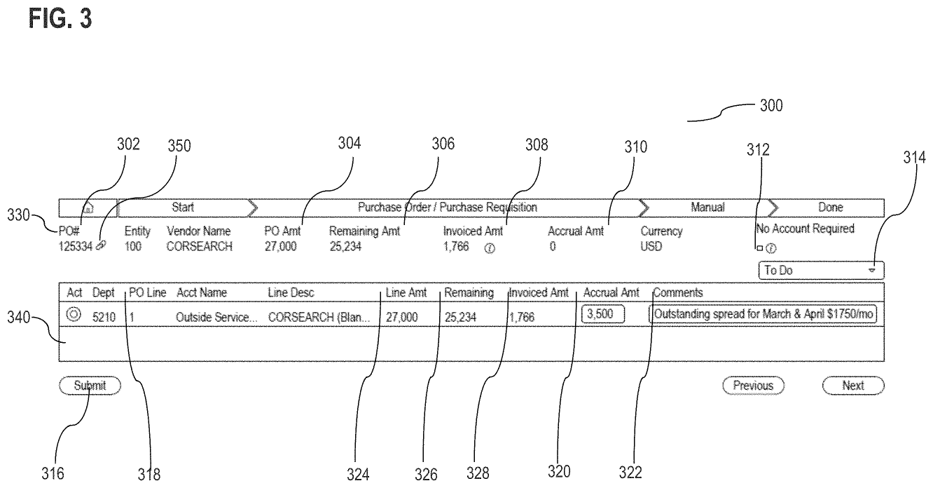

In some embodiments, the server 102 is programmed to receive a request from a requester computer 122 to access the accrual data. The server 102 is programmed to cause presentation of a graphical user interface (GUI) in response to the request. FIG. 3 illustrates an example GUI presented by requester computers having a screen for entering, reviewing, and updating accrual data associated with a purchase order. FIG. 3 and any other figure illustrates an example GUI is shown for purposes of illustrating a clear example and other embodiments may include more, fewer, or different elements presented in various shapes or forms or arranged in various manners.

In some embodiments, the screen 300 comprises an upper portion 330 and a lower portion 340. The upper portion 330 includes overall information regarding the purchase order, and the lower portion 340 includes information regarding each line of the purchase order.

In some embodiments, the upper portion 330 includes an identifier of the purchase order 302, the total purchase order amount 304, the total invoiced amount 308, the total remaining amount 306, and the total accrual amount 310. The upper portion 330 can include an option for accessing a copy of the original purchase order, such as the option 350. The total remaining amount 306 is the difference between the total purchase order amount 304 and the total invoiced amount 308 for the accrual period. Each of these total amounts is the sum of the amounts over individual lines of the purchase order. The upper portion 330 also includes an option 312 for indicating that no accrual is required for the purchase order. In response to a selection of the option 312, the GUI can set the accrual amount to zero and a corresponding comment to a default value indicating no accrual for each line of the purchase order, as further discussed below. The GUI can also present a prompt for a reason statement or supporting documents for no accrual for the entire purchase order, such as a copy of a later agreement (that has been executed by not yet accessible to the server 102) to cancel the purchase order before the end of the accrual period or copies of invoices that were subsequently issued having amounts that account for the expected accrual.

In some embodiments, the lower portion 340 can include an option 314 for selecting certain lines of the purchase order. The possible choices for the option 314 can include “To Do” corresponding to the set of lines that do not have an accrual amount, do not have a comment for the accrual amount, have a non-zero expected accrual amount, or satisfy other criteria associated with the “To Do” status, or “All” corresponding to the full set of lines of the purchase order. The lower portion 340 similarly shows, for one line of the purchase order, a line number 318, a purchase order amount 324, an invoiced amount 328, a remaining amount 326, and a field 320 for entering an accrual amount in the purchase order currency. The remaining amount 326 is the difference between the purchase order amount 324 and the invoiced amount 328. The field 320 can have a default value, such as null or the remaining amount 326. The actual value can be more when more goods or services were delivered above the line amount 324. The lower portion 340 also includes an option 322 for entering a comment for the accrual amount, which can be useful when the entered accrual amount is different from the expected accrual amount. The option 322 can accept free-form input or a selection of a plurality of predetermined choices. When the option 312 is selected, as noted above, the value for the field 320 is automatically set to and shown as zero and the value for the field 322 is automatically set to and shown as a specific value indicating no accrual.

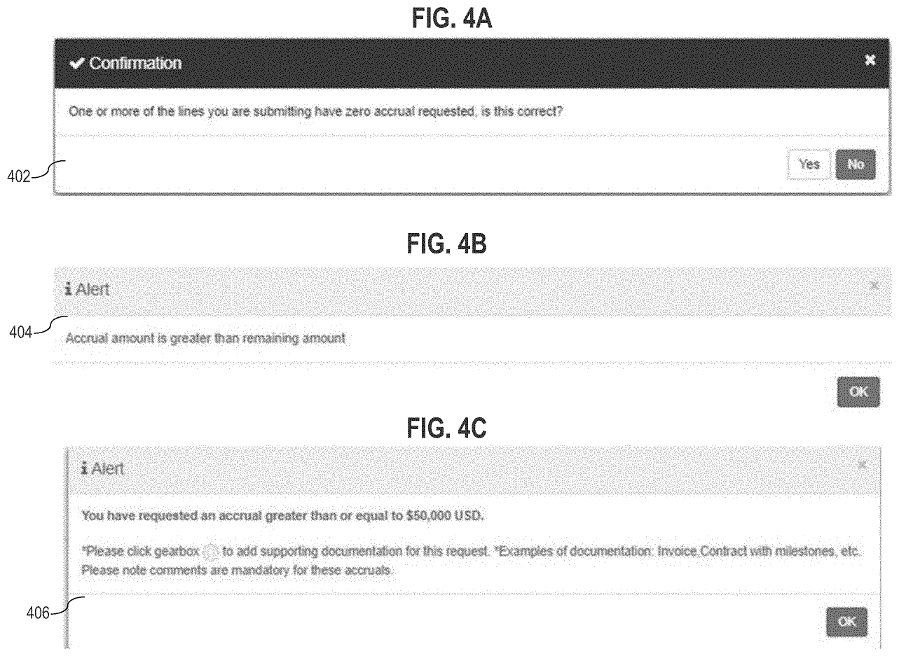

In some embodiments, the server 102 is programmed to perform different types of data validation through the GUI. FIG. 4A, FIG. 4B, and FIG. 4C illustrate example one or more GUIs having screens presented by requester computers for validating or confirming updates to accrual data.

In some embodiments, when the input value for the field 320 is zero, the GUI can present a prompt for confirming or cancelling input. FIG. 4A illustrates an example GUI having a screen for handling a zero accrual amount for a line of the purchase order. In response to a confirmation, the GUI can further replace previously inputted value for the field 322 with a specific value, such as “No Accrual”. Alternatively, the GUI can require an input for the field 322 or a selection of one of the choices for the field 322 indicating reasons for a zero accrual, such as a later agreement (that has been executed by not yet accessible to the server 102) to cancel the order corresponding to this line of the purchase order, discount the price of the order, or increase the price invoiced for this order before the end of the accrual period. In response to a cancellation, the GUI can reset the value of the field 320 to the default amount and prompt for a new input.

In some embodiments, when the input value for the field 320 is greater than the remaining amount 326, the GUI can similarly present a prompt for confirming or cancelling input. FIG. 4B illustrates an example GUI having a screen for handling an accrual amount that is larger than the remaining amount for a line of the purchase order. In response to a confirmation, the GUI can require an input for the field 322 or a selection of one of the choices for the field 322 indicating reasons for an accrual larger than the expected amount, such as a later agreement (that has been executed by not yet accessible to the server 102) to increase of the price of order corresponding to this line of the purchase order or to reduce the price already invoiced for this order before the end of the accrual period. In response to a cancellation, the GUI can reset the value of the field 320 to the default amount and prompt for a new input.

In some embodiments, when the input value for the field 320 is greater than a specific threshold independent of the remaining amount 326, the GUI can similarly present a prompt for confirming or cancelling input. FIG. 4C illustrates an example GUI having a screen for handling an accrual amount that is larger than a specific threshold for a line of the purchase order. In response to a confirmation, the GUI can require an input for the field 322 or a selection of one of the choices for the field 322 indicating reasons for an accrual larger than the expected amount, such as a significant delay in invoicing, difficult in invoicing large amounts, or other reasons that also apply to the scenario where the input value for the field 320 is great than the remaining amount 326, as discussed above. Alternatively, the GUI can request provision of supporting documents, such as those documents mentioned in the reason provided for the field 322, which can also be done for the other data validation scenarios noted above. In response to a cancellation or a failure to provide supporting documents, the GUI can reset the value of the field 320 to the default amount and prompt for a new input.

In some embodiments, the screen 300 includes an option 316 for submitting the values provided for the different fields contained therein. The option 316 may be disabled until various constraints are satisfied, such as providing a comment or a supporting document for a specific accrual amount. In response to the selection of the option 316, the server is programmed to store the values in a database. For an update to one of the fields in the screen 300, the server 102 can be programmed to create an entry in a log, including information identifying the purchase order or the line of the purchase order, the updated value, the source of the updated value, the time when the update was made, etc. In addition, a field can be associated with a notification trigger. For example, such a trigger may include a condition of when the value for the field 320 satisfies a certain criterion or when the value of the field 322 is updated and a corresponding action that a notification is sent to a planning and analysis computer 124. The server 102 can be programmed to further determine whether the condition of any trigger is satisfied and perform the action of the trigger as appropriate.

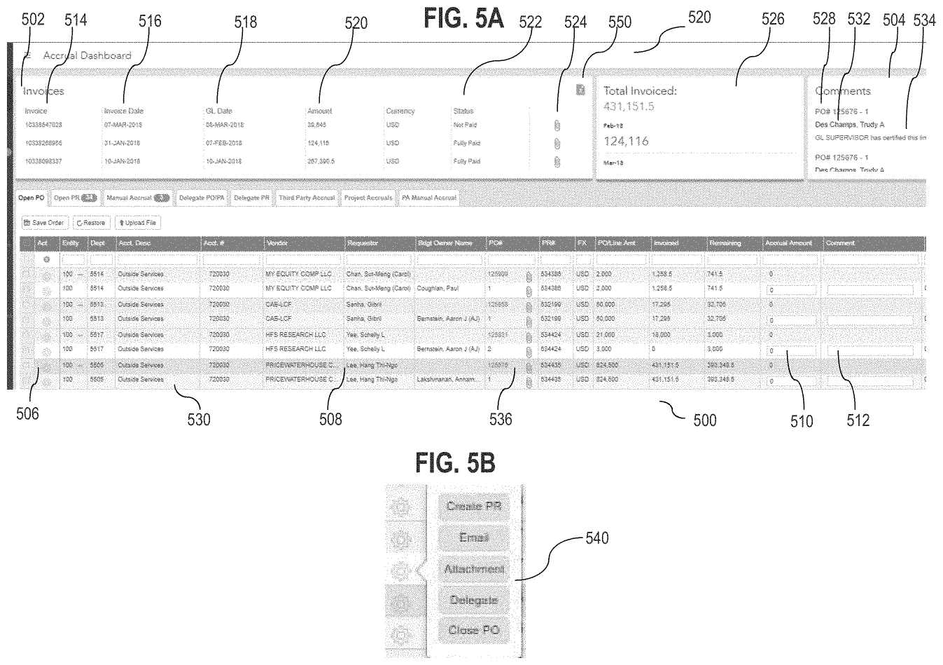

In some embodiments, the server 102 is programmed to receive a request from a planning and analysis computer 124 to access the accrual data. The server 102 is programmed to cause presentation of a GUI in response to the request. FIG. 5A illustrates an example GUI presented by a planning and analysis computer having a screen for reviewing accrual data and associated invoice data and updating the accrual data associated with one or more purchase orders.

In some embodiments, the screen 500 comprises an upper portion 520 and a lower portion 530. The upper portion 520 includes information regarding the invoices associated with certain purchase orders, such as open purchase orders that have been assigned to the planning and analysis computer 124 for further review and certification. The lower portion 530 includes information regarding the certain purchase orders, such as accrual data for each line of the certain purchase orders.

In some embodiments, the upper portion 520 includes a listing 502 of the invoices associated with the certain purchase orders and for each invoice, an invoice identifier 514, an invoice date 516, a general ledger date 518, an amount 520, a status 522, and an option 524 to obtain a copy of the original invoice. The upper portion 550 can also include an export option 540 for exporting the listing 502. The general ledger date 518 indicates when the invoice is received by the general ledger system 130, which can be the date when the invoice is available to the server 102. The status 522 indicates how much of the invoice has been paid. The server 102 can be programmed to retrieve the status from the general ledger system 130. Alternatively, the server 102 can be programmed to also retrieve the receipts from the general ledger system 130 and determine the payment status for the invoice. In other embodiments, the upper portion 520 includes a listing 502 of the invoices associated with a line of one of the certain purchase orders instead, such as the one selected in the lower portion 530, as further discussed below. The upper portion 520 also comprises a section 526 showing aggregate invoice data corresponding to the listing 502 of the invoices, such as the total amount on a set of dates during or before the accrual period. The upper portion 520 can also comprise a comments section 504 that includes list of comments associated with the certain purchase orders, and for each comment, a corresponding purchase order identifier and line number 528, a source identifier 532 naming the party who entered the comment, and the comment 534, such as that a general ledger supervisor has certified the accrual corresponding to that line of the purchase order. In other embodiments, the upper portion 520 can comprise a comments section 504 that includes a list of comments associated with a line of one of the certain purchase orders instead, such as the one selected in the lower portion 530.

In some embodiments, the lower portion 530 includes line items having information for different line of the certain purchase orders. Each line item can include the identifier of a requester 508 associated with a requester computer that has submitted the accrual data for the line of the purchase order, such as through a GUI presented by the requester computer 122, as illustrated in FIG. 3. Each line item can also include the purchase order identifier and line number 536 of one of the certain purchase orders. In addition, each line item can include portions similar to the information included in the GUI presented by the requester computer 122 for each line of a purchase order, as illustrated in FIG. 3. Such portions may include a field 510 for entering an accrual amount and a field 512 for entering a corresponding comment. The field 510 can have a default value, such as null or the value submitted by the requester computer 122. The input value for the field 510 can be the first accrual value manually entered for the line of the purchase order (as no requester computer 122 has submitted an accrual amount for this line). Alternatively, the input value for the field 510 can override the value submitted by the requester computer 122, which can trigger a notification to the requester computer 122. The field 512 can also have a default value, such as null or the value submitted by the requester computer 122. The input value for the field 512 can provide another reason for the default value for the field 510, a new reason for a new value for the field 510, or a new reason for overriding the default value for the field 510 with a new value. The input value for the field 512 can also trigger a notification to the requester computer 122.

In some embodiments, the line item can additionally include an option 506 for additionally managing data related to the corresponding line of the purchase order, which can also be included in the GUI presented by a requester computer 122, as illustrated in FIG. 3. FIG. 5B illustrates an example GUI having a screen for issuing an instruction on managing data related to a line of the purchase order. Upon receiving a selection of the option 506, the GUI can present a list 504 of further actions related to the line of the purchase order, such as creating a purchase requisition that might have somehow been skipped, emailing the accrual data for the line, the corresponding purchase order, or the corresponding invoices to a certain party, attaching supporting documents for the line, delegating another party to review and certify this line, or closing the line of the corresponding purchase order. The closing can be extended to the entire purchase order when a purchase header is shown and selected and all the lines of the purchase order can be accessed by the planning and analysis computer 124. In addition, the closing can be in response to a request from a requester computer 122 to close the purchase order. For example, the server 102 can be configured to enforce a wait period of 45 days from when the request was received, during which a response from the planning and analysis computer 124 is expected. Furthermore, the closing can be coordinated with a soft close of the purchase order by the general ledger system 130. The selection of any of the list 506 of further actions may trigger a notification of a relevant party, such as an accounting computer 126 associated with a general ledger manager, requiring further confirmation or approval from the relevant party.

In some embodiments, the lower portion 530 may receive scrolling signals from a planning and analysis computer 124 as relevant data corresponding to different lines of the certain purchase orders are being reviewed. As the scrolling occurs, one of the line items (e.g., the one currently in the center of the lower portion 530) can be automatically selected. Alternatively, a selection might occur in response to an explicit selection signal from the planning and analysis computer 124. As the selection changes, the data displayed in the upper portion 520 can change accordingly, as noted above. For example, the accrual data corresponding to a selected line item may have been submitted by a requester computer 122, previously certified by the planning and analysis computer 124, and later de-certified by an accounting computer 126, as further discussed below. The comments section 504 can then include three entries respectively corresponding to the submission, certification, and de-certification.

In some embodiments, the server 102 is programmed to identify missing or incorrect accrual data and present the identification result to a planning and analysis computer 124. For a vendor of goods or services covered in the certain purchase orders, the server 102 can be programmed to determine trends in accrual amounts or invoicing percentages (amount invoiced vs. amount ordered) over the accrual periods in one or more previous seasons and generate an alert when the accrual data in the current accrual period is inconsistent with a determined trend. The server 102 can be configured to cause presentation of a GUI by the planning and analysis computer 124 that includes the trend data or the alert. The GUI can further include options for creating new accrual data or correcting existing accrual data based on the trend data or in response to the alert.

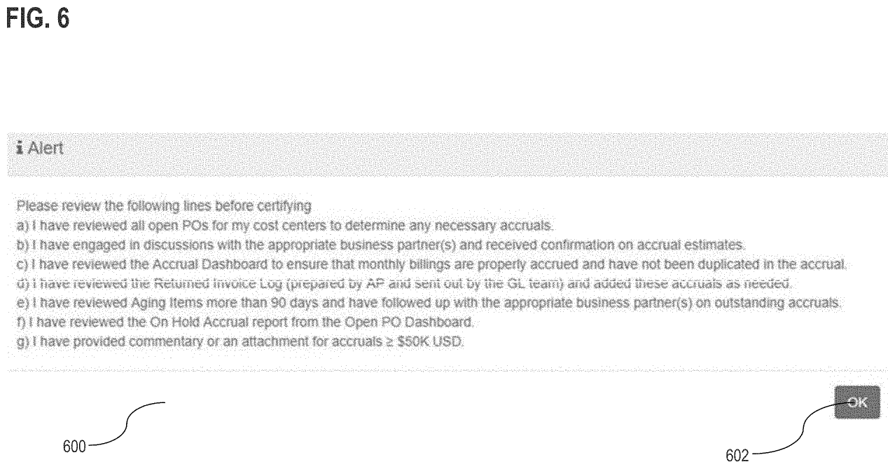

In some embodiments, the server 102 is programmed to cause presentation of a GUI by the planning and analysis computer 124 to further facilitate the review and certification of the accrual data for the certain purchase orders. FIG. 6 illustrates an example GUI presented by a planning and analysis computer having a screen for certifying one or more accruals associated with certain purchase orders. The screen 600 lists one or more review and verification tasks regarding accrual data that need to be completed before a certification of the accrual data via the selection of the option 602. The GUI can comprise other screens that facilitate the completion of one or more of these tasks, such as an option to compare the accrual data processed in a prior accrual period with the accrual data processed in the present accrual period, to identify and submit returned invoices, or to designate and review on-hold accruals. The certification of the accrual data can trigger a notification to an accounting computer 126 for further review and final approval of the accrual data. A de-certification instead of a final approval from an accounting computer 126 can trigger a notification back to the planning and analysis computer 124, which can be configured to restart the certification process. Such de-certification status can also be reflected in the comments section 504, as described above, or otherwise flagged in a GUI presented by the planning and analysis computer 124.

In some embodiments, a requester computer 122 is associated with a project manager of a project. Each project may have a category and involve one or more purchase requisitions or corresponding purchase orders. The project categories may be selected based on project lifecycles and similar depreciation asset classes. The accrual process for a project is managed for each project category based on a mapping between project categories and purchase requisitions or corresponding purchase orders. The accrual process for a project similarly flows through requester computers 122, planning and analysis computers 124, and account computers 126, as discussed above. A requester computer 122 can be programmed to provide a business forecast amount for a project category to the general ledger system 130.

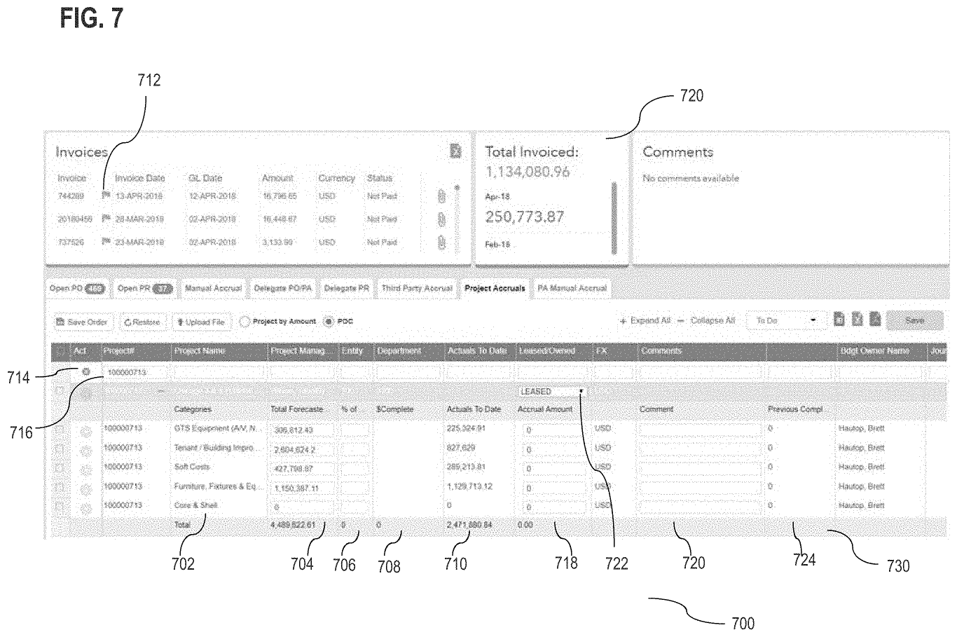

FIG. 7 illustrates an example GUI presented by a requester computer or a planning and analysis computer having a screen for reviewing accrual data and associated invoice data for a project and updating the accrual data associated with one or more categories.

In some embodiments, the screen 700 comprises an upper portion 720 and a lower portion 730. The upper portion 720 is similar to the upper portion 520 in FIG. 5 except that it includes information regarding the invoices associated with a project. More specifically, the upper portion 720 may show values specific to a chosen project (such as the one indicated by the project header 716 discussed below) and include a green flag 712 denoting the invoices entered before the accrual period begins and thus would be part of the accrual process. The lower portion 730 includes information regarding different categories of the project.

In some embodiments, the lower portion 730 indicates a project header, (number, short name, manager name, company entity number, department, etc. in the current accrual period) 716, and an option 714 that can be used to hide the section below for individual categories. The section below includes an option 722 for switching between lease or owned, which impacts accrual accounts used due to different depreciation calculation values and asset class types. The section below further includes line items having information for individual categories of the project. Each line item can include a category name 702. Each line item can include a field 704 for inputting the latest total baselined forecasted amount, which is pre-populated by data retrieved from the general ledger system 130, for example. Each line item can also include a field 706 for inputting a percentage of project completion as of the accrual period and a value 708 of a dollar amount of completion corresponding to the value of the field 704. Specifically, the value 708 is calculated as the value of the field 704 multiplied by the value of the field 706. In addition, each line item can include a value 710 of the actuals from project inception to date for the current accrual period, which is calculated as the total amount of invoices mapped to the project category and considered in the accrual process. Each line item can further include a field 718 for inputting an accrual amount that has a default value equal to the value of 708 minus the value of 710. Each line item can further include a field 720 for inputting a comment. The field 720 can show prior comments for the corresponding category when the project header 716 is selected. In addition, each line item can include a value 724 of the accrual amount form the prior accrual period.

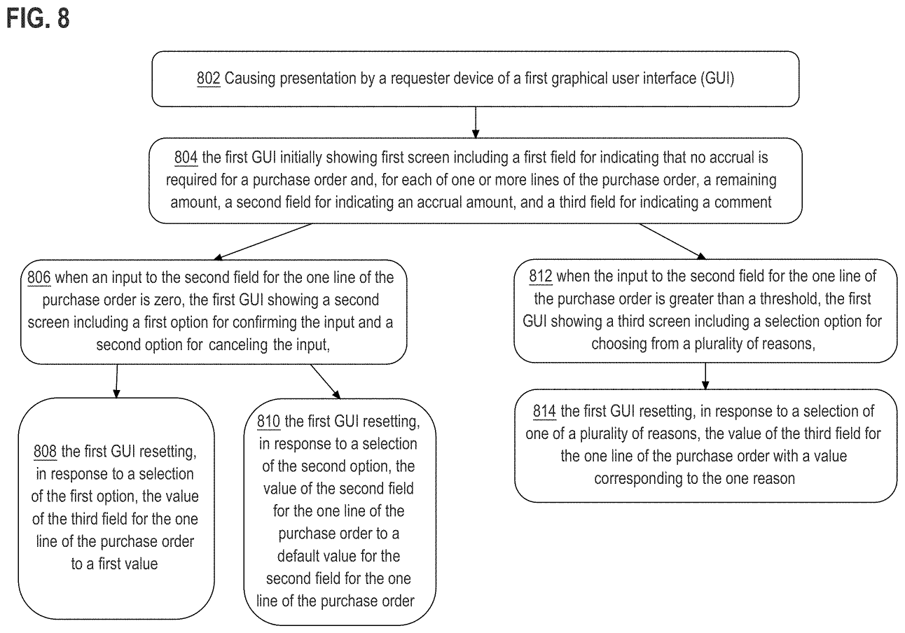

FIG. 8 illustrates an example process performed by the accrual server computer. FIG. 8 is shown in simplified, schematic format for purposes of illustrating a clear example and other embodiments may include more, fewer, or different elements connected in various manners. FIG. 8 is intended to disclose an algorithm, plan or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In some embodiments, in step 802, the server 102 is programmed to send, to a requester device, instructions which when executed cause presentation of a first GUI. In step 804, the first GUI initially shows a first screen including a first field for indicating that no accrual is required for a purchase order and, for each of one or more lines of the purchase order, a remaining amount, a second field for indicating an accrual amount, and a third field for indicating a comment. The remaining amount is generally the difference between the order amount and the amount invoiced so far for that line of the purchase order. The second field may have a default value, such as null or the remaining amount.

In some embodiments, when an input to the second field for the one line of the purchase order is zero indicating a zero accrual, in step 806, the first GUI shows a second screen including a first option for confirming the input and a second option for cancelling the input. The second screen can be superimposed on the first screen. The second screen can be shown anytime from the receipt of the input to the second field to the receipt of a selection to submit all the data inputted via the first screen. In response to a selection of the first option to confirm the input, in step 808, the first GUI resets the value of the third field for the one line of the purchase order to a first value, such as “No Accrual”, regardless of the current value of the third field. In response to a selection of the second option, the first GUI resets the value of the second field for the one line of the purchase order to a default value for the second field for the one line of the purchase order, as noted above. The first GUI can also add a second value to the third field, such as “Submission canceled”.

In some embodiments, when the input to the second field for the one line of the purchase order is greater than a threshold, such as $50,000, in step 812, the first GUI shows a third screen including a selection option for choosing from a plurality of reasons. The third screen can similarly be superimposed on the first screen. The third screen can be shown anytime from the receipt of the input to the second field to the receipt of a selection to submit all the data inputted via the first screen. In response to receiving a selection of one of a plurality of reasons, in step 814, the first GUI resets the value of the third field for the one line of the purchase order with a value corresponding to the one reason. The third screen can also include a prompt for providing supporting documents, such as a copy of a later agreement mentioned in the selected reason. When the input to the second field is greater than the remaining amount, which can be smaller than the threshold, the plurality of reasons can include an agreement to, for the line of the purchase order, increase an order quantity or price, decrease an invoice amount, or cancel an invoice.

In some embodiments, as input is received via any of the first, second, or third screens, the instructions when executed can further cause recordation of an entry corresponding to the input into a log or immediate transmission of the input or a notification thereof to another device, such as the source of the instructions or another device programmed to further process the input.

### Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

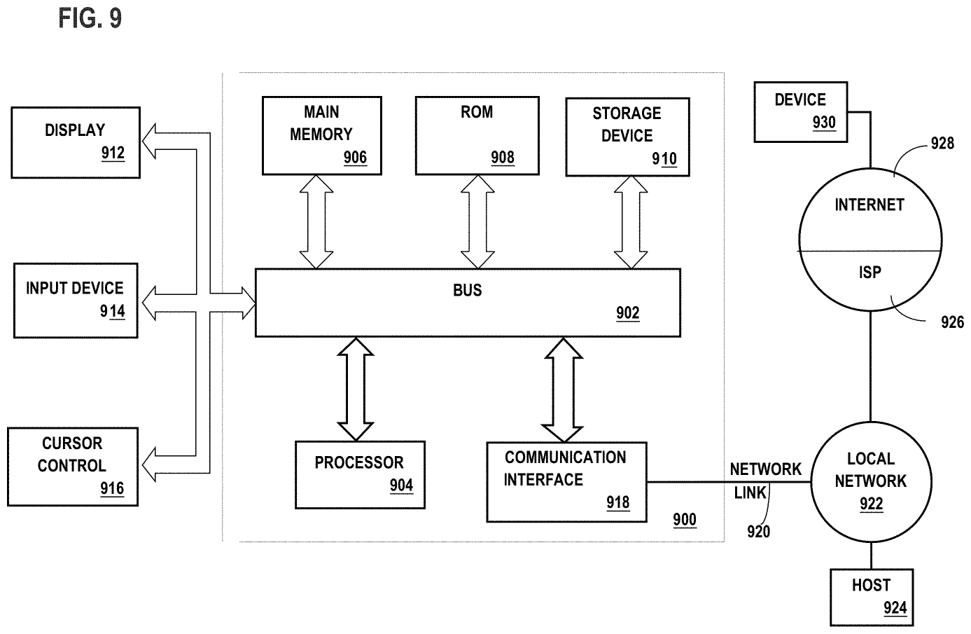

FIG. 9 is a block diagram that illustrates an example computer system with which an embodiment may be implemented. In the example of FIG. 9, a computer system 900 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 900 includes an input/output (I/O) subsystem 902 which may include a bus and/or other communication mechanism(s) for communicating information and/or instructions between the components of the computer system 900 over electronic signal paths. The I/O subsystem 902 may include an I/O controller, a memory controller and at least one I/O port. The electronic signal paths are represented schematically in the drawings, for example as lines, unidirectional arrows, or bidirectional arrows.

At least one hardware processor 904 is coupled to I/O subsystem 902 for processing information and instructions. Hardware processor 904 may include, for example, a general-purpose microprocessor or microcontroller and/or a special-purpose microprocessor such as an embedded system or a graphics processing unit (GPU) or a digital signal processor or ARM processor. Processor 904 may comprise an integrated arithmetic logic unit (ALU) or may be coupled to a separate ALU.

Computer system 900 includes one or more units of memory 906, such as a main memory, which is coupled to I/O subsystem 902 for electronically digitally storing data and instructions to be executed by processor 904. Memory 906 may include volatile memory such as various forms of random-access memory (RAM) or other dynamic storage device. Memory 906 also may be used for storing temporary variables or other intermediate information during execution of instructions to be executed by processor 904. Such instructions, when stored in non-transitory computer-readable storage media accessible to processor 904, can render computer system 900 into a special-purpose machine that is customized to perform the operations specified in the instructions.

Computer system 900 further includes non-volatile memory such as read only memory (ROM) 908 or other static storage device coupled to I/O subsystem 902 for storing information and instructions for processor 904. The ROM 908 may include various forms of programmable ROM (PROM) such as erasable PROM (EPROM) or electrically erasable PROM (EEPROM). A unit of persistent storage 910 may include various forms of non-volatile RAM (NVRAM), such as FLASH memory, or solid-state storage, magnetic disk or optical disk such as CD-ROM or DVD-ROM, and may be coupled to I/O subsystem 902 for storing information and instructions. Storage 910 is an example of a non-transitory computer-readable medium that may be used to store instructions and data which when executed by the processor 904 cause performing computer-implemented methods to execute the techniques herein.

The instructions in memory 906, ROM 908 or storage 910 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file processing instructions to interpret and render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 900 may be coupled via I/O subsystem 902 to at least one output device 912. In one embodiment, output device 912 is a digital computer display. Examples of a display that may be used in various embodiments include a touch screen display or a light-emitting diode (LED) display or a liquid crystal display (LCD) or an e-paper display. Computer system 900 may include other type(s) of output devices 912, alternatively or in addition to a display device. Examples of other output devices 912 include printers, ticket printers, plotters, projectors, sound cards or video cards, speakers, buzzers or piezoelectric devices or other audible devices, lamps or LED or LCD indicators, haptic devices, actuators or servos.

At least one input device 914 is coupled to I/O subsystem 902 for communicating signals, data, command selections or gestures to processor 904. Examples of input devices 914 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 916, which may perform cursor control or other automated control functions such as navigation in a graphical interface on a display screen, alternatively or in addition to input functions. Control device 916 may be a touchpad, a mouse, a trackball, or cursor direction keys for communicating direction information and command selections to processor 904 and for controlling cursor movement on display 912. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 914 may include a combination of multiple different input devices, such as a video camera and a depth sensor.

In another embodiment, computer system 900 may comprise an internet of things (IoT) device in which one or more of the output device 912, input device 914, and control device 916 are omitted. Or, in such an embodiment, the input device 914 may comprise one or more cameras, motion detectors, thermometers, microphones, seismic detectors, other sensors or detectors, measurement devices or encoders and the output device 912 may comprise a special-purpose display such as a single-line LED or LCD display, one or more indicators, a display panel, a meter, a valve, a solenoid, an actuator or a servo.

When computer system 900 is a mobile computing device, input device 914 may comprise a global positioning system (GPS) receiver coupled to a GPS module that is capable of triangulating to a plurality of GPS satellites, determining and generating geo-location or position data such as latitude-longitude values for a geophysical location of the computer system 900. Output device 912 may include hardware, software, firmware and interfaces for generating position reporting packets, notifications, pulse or heartbeat signals, or other recurring data transmissions that specify a position of the computer system 900, alone or in combination with other application-specific data, directed toward host 924 or server 930.

Computer system 900 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 900 in response to processor 904 executing at least one sequence of at least one instruction contained in main memory 906. Such instructions may be read into main memory 906 from another storage medium, such as storage 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 910. Volatile media includes dynamic memory, such as memory 906. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 902. Transmission media can also take the form of acoustic or light waves, such as those generated during radio-wave and infra-red data communications.

Various forms of media may be involved in carrying at least one sequence of at least one instruction to processor 904 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 900 can receive the data on the communication link and convert the data to be read by computer system 900. For instance, a receiver such as a radio frequency antenna or an infrared detector can receive the data carried in a wireless or optical signal and appropriate circuitry can provide the data to I/O subsystem 902 such as place the data on a bus. I/O subsystem 902 carries the data to memory 906, from which processor 904 retrieves and executes the instructions. The instructions received by memory 906 may optionally be stored on storage 910 either before or after execution by processor 904.

Computer system 900 also includes a communication interface 918 coupled to bus 902. Communication interface 918 provides a two-way data communication coupling to network link(s) 920 that are directly or indirectly connected to at least one communication networks, such as a network 922 or a public or private cloud on the Internet. For example, communication interface 918 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 922 broadly represents a local area network (LAN), wide-area network (WAN), campus network, internetwork or any combination thereof. Communication interface 918 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 918 sends and receives electrical, electromagnetic or optical signals over signal paths that carry digital data streams representing various types of information.

Network link 920 typically provides electrical, electromagnetic, or optical data communication directly or through at least one network to other data devices, using, for example, satellite, cellular, Wi-Fi, or BLUETOOTH technology. For example, network link 920 may provide a connection through a network 922 to a host computer 924.

Furthermore, network link 920 may provide a connection through network 922 or to other computing devices via internetworking devices and/or computers that are operated by an Internet Service Provider (ISP) 926. ISP 926 provides data communication services through a world-wide packet data communication network represented as internet 928. A server computer 930 may be coupled to internet 928. Server 930 broadly represents any computer, data center, virtual machine or virtual computing instance with or without a hypervisor, or computer executing a containerized program system such as DOCKER or KUBERNETES. Server 930 may represent an electronic digital service that is implemented using more than one computer or instance and that is accessed and used by transmitting web services requests, uniform resource locator (URL) strings with parameters in HTTP payloads, API calls, app services calls, or other service calls. Computer system 900 and server 930 may form elements of a distributed computing system that includes other computers, a processing cluster, server farm or other organization of computers that cooperate to perform tasks or execute applications or services. Server 930 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 930 may comprise a web application server that hosts a presentation layer, application layer and data storage layer such as a relational database system using structured query language (SQL) or no SQL, an object store, a graph database, a flat file system or other data storage.

Computer system 900 can send messages and receive data and instructions, including program code, through the network(s), network link 920 and communication interface 918. In the Internet example, a server 930 might transmit a requested code for an application program through Internet 928, ISP 926, local network 922 and communication interface 918. The received code may be executed by processor 904 as it is received, and/or stored in storage 910, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 904. While each processor 904 or core of the processor executes a single task at a time, computer system 900 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
causing presentation of a first graphical user interface (GUI),
the first GUI initially showing a first screen including a first field for indicating that no accrual is required for a purchase order and, for each of one or more lines of the purchase order, a remaining amount, a second field for indicating an accrual amount, and a third field for indicating a comment;
when an input to the second field for the one line of the purchase order is zero, the first GUI showing a second screen including a first option for confirming the input and a second option for cancelling the input,
the first GUI resetting, in response to a selection of the first option, the value of the third field for the one line of the purchase order to a first value,
the first GUI resetting, in response to a selection of the second option, the value of the second field for the one line of the purchase order to a default value for the second field for the one line of the purchase order,
when the input to the second field for the one line of the purchase order is greater than a threshold, the first GUI showing a third screen including a selection option for choosing from a plurality of reasons,
the first GUI resetting, in response to a selection of one of a plurality of reasons, the value of the third field for the one line of the purchase order with a value corresponding to the one reason,
wherein the method is performed by one or more computing devices.

2. The method of claim 1, in response to a selection of the first field, for each of the one or more lines of the purchase order, the first GUI resetting the value of the second field to zero and the value of the third field to the first value.

3. The method of claim 1, the default value for the second field being the remaining amount for the one line of the purchase order.

4. The method of claim 1, when the input to the second field is greater than the remaining amount for the line of the purchase order, the plurality of reasons including an agreement to, for the line of the purchase order, increase an order quantity or price, decrease an invoiced amount, or cancel an invoice.

5. The method of claim 1, the third screen further including a prompt for a supporting document.

6. The method of claim 1, the first screen further including a third option for submitting data inputted via the first screen,
in response to receiving a selection of the third option, transmitting a notification to a planning and analysis computer.

7. The method of claim 1, further comprising
causing presentation by a planning and analysis computer of a second GUI,
the second GUI initially showing a fourth screen including a list of accrual items corresponding to multiple lines of a set of purchase orders, invoice data related to the set of purchase orders, and a list of log entries related to the list of accrual items.

8. The method of claim 7, one of the list of accrual items including an identifier of a corresponding purchase order, a line number, an identifier associated with a requester computer that submitted data for the one accrual item, a fourth field for indicating an accrual amount, and a fifth field for indicating a comment.

9. The method of claim 8, the fifth field having a default value of an amount submitted by the requester computer.

10. The method of claim 8, one of the log entries including the identifier of the purchase order, the line number, a description of an action related to the one accrual item, an identifier of a party performing the action, and a date when the action was performed.

11. The method of claim 7, the second GUI showing, in response to a selection of one of the list of accrual items, a fifth screen including a plurality of choices for managing the corresponding purchase order, including creating a purchase requisition or closing the purchase order.

12. The method of claim 7, the second GUI replacing, in response to a new selection of a second of the set of accrual items, the set of comments with a new set of comments corresponding to the second accrual item.

13. The method of claim 7,
the fourth screen further including a third option for submitting data included in one or more of the list of accrual items,
the second GUI showing, in response to a selection of the third option, presentation of a fifth screen including a fourth option for certifying validity of submitted data.

14. The method of claim 13, in response to receiving a selection of the fourth option, transmitting a notification to an account manager computer.

15. One or more non-transitory storage media storing instructions which, when executed by one or more computing devices, cause performance of a method, the method comprising:
causing presentation of a first graphical user interface (GUI),
the first GUI initially showing a first screen including a first field for indicating that no accrual is required for a purchase order and, for each of one or more lines of the purchase order, a remaining amount, a second field for indicating an accrual amount, and a third field for indicating a comment;
when an input to the second field for the one line of the purchase order is zero, the first GUI showing a second screen including a first option for confirming the input and a second option for cancelling the input,
the first GUI resetting, in response to a selection of the first option, the value of the third field for the one line of the purchase order to a first value,
the first GUI resetting, in response to a selection of the second option, the value of the second field for the one line of the purchase order to a default value for the second field for the one line of the purchase order,
when the input to the second field for the one line of the purchase order is greater than a threshold, the first GUI showing a third screen including a selection option for choosing from a plurality of reasons,
the first GUI resetting, in response to a selection of one of a plurality of reasons, the value of the third field for the one line of the purchase order with a value corresponding to the one reason.

16. The one or more transitory storage media of claim 15, in response to a selection of the first field, for each of the one or more lines of the purchase order, the first GUI resetting the value of the second field to zero and the value of the third field to the first value.

17. The one or more transitory storage media of claim 15, the third screen further including a prompt for a supporting document.

18. The one or more transitory storage media of claim 15, the method further comprising
causing presentation by a planning and analysis computer of a second GUI,
the second GUI initially showing a fourth screen including a list of accrual items corresponding to multiple lines of a set of purchase orders, invoice data related to the set of purchase orders, and a list of log entries related to the list of accrual items.

19. The one or more transitory storage media of claim 15, one of the list of accrual items including an identifier of a corresponding purchase order, a line number, an identifier associated with a requester computer that submitted data for the one accrual item, a fourth field for indicating an accrual amount, and a fifth field for indicating a comment.

20. The one or more transitory storage media of claim 15, the second GUI replacing, in response to a new selection of a second of the set of accrual items, the set of comments with a new set of comments corresponding to the second accrual item.
